(19) United States
(12) Patent Application Publication
(10) Pub. No.: US 2010/0022020 A1
(43) Pub. Date: Jan. 28, 2010

(54) Compositions for surface enhanced infrared absorption spectra and methods of using same

(76) Inventors: Nancy J. Halas, Houston, TX (US); Janardan Kundu, Houston, TX (US); Fei Le, Houston, TX (US); Peter Nordlander, Houston, TX (US); Hui Wang, Austin, TX (US)

Correspondence Address: CONLEY ROSE, P.C., 5601 GRANITE PARKWAY, SUITE 750, PLANO, TX, 75024, US

(21) Appl. No.: 12/439,251

(22) PCT Filed: Aug. 31, 2007
(86) PCT No.: PCT/US07/77389

§ 371 Date: Jul. 16, 2009

Related U.S. Application Data
(60) Provisional application No. 60/842,089, filed on Sep. 1, 2006.

(51) Int. Cl. G01N 21/65

(52) U.S. Cl. 436/171

(57) ABSTRACT

A composition comprising a substrate and at least one adsorbate associated with the substrate wherein the composition has an enhanced infrared absorption spectra. A method comprising tuning a nanoparticle to display a plasmon resonance in the infrared, associating an adsorbate with the nanoparticle to form an adsorbate associated nanoparticle, and aggregating the adsorbate associated nanoparticle. A method of preparing a SERS-SEIRA composition comprising fabricating a nanoparticle substrate, functionalizing the nanoparticle substrate to form a functionalized substrate, dispersing the functionalized substrate in solution to form a dispersed functionalized substrate, and associating the dispersed functionalized substrate with a medium.

### CROSS-REFERENCE TO RELATED APPLICATIONS

The present application claims priority to U.S. Provisional Patent Application Ser. No. 60/842,089 filed Sep. 1, 2006 and entitled “Surface Enhanced Infrared Absorption (SEIRA) Spectroscopy Using Infrared Resonant Nanoshell Aggregate Substrates.”

### STATEMENT REGARDING FEDERALLY SPONSORED RESEARCH OR DEVELOPMENT

This work was supported by the National Science Foundation (NSF) Grants EEC-0304097 and ECS-0421108, AFOSR FA9550-06-1-0021, Robert A. Welch Foundation C-1220 and C-1222, the Multidisciplinary University Research Initiative (MURI) of the Department of Defense W911NF-04-01-0203.

### BACKGROUND

The dramatic changes observed in the optical properties of molecules when adsorbed on or near structured metal surfaces of various topologies, such as metallic nanoparticles or metal island films, has led to an intense resurgence of interest in the topic of surface enhanced spectroscopies. The best-known example is surface enhanced Raman scattering (SERS), where enhancement factors as high as 10¹⁵ have been reported, enabling detection at the single molecule level for certain molecules. SERS has been reported with excitation at both visible and near-infrared (NIR) wavelengths. Surface enhanced spectroscopy can also be performed by direct mid-IR excitation of molecules on metal structures, resulting in enhanced absorption at wavelengths corresponding to the dipole-active vibrational transitions of the molecules. This spectroscopy is known as surface enhanced infrared absorption (SEIRA). In SEIRA, all vibrational modes of the molecule with a change in dipole moment perpendicular to the substrate surface are preferentially enhanced. Therefore, SEIRA has outstanding potential as a surface enhanced spectroscopy complementary to SERS, allowing excitation of the non-Raman-active vibrational modes of the molecule. SEIRA also provides a straightforward signature of the orientation of adsorbate moieties with respect to the surface normal, valuable information for elucidating molecular structure. Thus, there exists an ongoing need for compositions useful for SEIRA and methods of using same.

### SUMMARY

Disclosed herein is a composition comprising a substrate and at least one adsorbate associated with the substrate wherein the composition has an enhanced infrared absorption spectra.

Also disclosed herein is a method comprising tuning a nanoparticle to display a plasmon resonance in the infrared, associating an adsorbate with the nanoparticle to form an adsorbate associated nanoparticle, and aggregating the adsorbate associated nanoparticle.

Further disclosed herein is a method of preparing a SERS-SEIRA composition comprising fabricating a nanoparticle substrate, functionalizing the nanoparticle substrate to form a functionalized substrate, dispersing the functionalized substrate in solution to form a dispersed functionalized substrate, and associating the dispersed functionalized substrate with a medium.

### BRIEF DESCRIPTION OF THE DRAWINGS

FIG. 1 is the scanning electron microscopy image (SEM) of nanoshell aggregate film on glass with single nanoshell inset.

FIG. 2 shows (i) the experimental extinction spectrum of the nanoshell aggregate film on a glass substrate and (ii) the calculated extinction spectrum of constituent nanoshells (spectra offset for clarity).

FIG. 3 is the experimental near-IR to mid-IR extinction spectrum of a nanoshell aggregate film on silicon.

FIG. 4 is a representative SEM image of the nanoshell aggregate film on silicon used as a SEIRA substrate.

FIG. 5 shows (i) the transmission SEIRA spectra of para-mercaptoaniline on nanoshell aggregates and (ii) the transmission spectra of neat para-mercaptoaniline (spectra offset for clarity).

FIG. 6 is a graph of the enhancement factors obtained by SEIRA for various IR modes of para-mercaptoaniline.

FIG. 7 shows (i) the transmission spectra of neat adenine and (ii) the SEIRA spectra of adenine on nanoshell aggregates (spectra offset for clarity). The inset shows the high wavenumber SEIRA spectra.

FIG. 8 shows the histogram of a representative nanoshell aggregate SEIRA substrate statistically characterizing nanoshell aggregation (n=2 represents dimer, n=3 represents trimer, etc.)

FIG. 9 shows the FDTD simulated local field enhancements for a (a) dimer, (b) trimer and (c) quadrumer. The incident direction and polarization of light are illustrated in the figure along with the scale bar for near field enhancements. In each local field enhancement panel, all pixels with a field enhancement factor greater than 10 are colored white, indicating the hot spot area used for SEIRA enhancement factor calculation. The maximum of the local field for each simulated case is quoted in the figure.

FIG. 10 shows (a) Schematic illustration of the fabrication of Au nanoshell arrays, (b,c) SEM images of nanoshell arrays formed by drying 40 μL of CTAB-capped Au nanoshell aqueous solutions on silicon wafers. The core radius of the nanoshells is 150 nm±12 nm, and shell thickness is 22±1 nm, and (d) TEM images of the nanoshell arrays formed a TEM grid.

FIG. 11 shows the normal incidence extinction spectra of monolayer nanoshell arrays (solid curves) and submonolayers of isolated nanoshells (dashed curved) supported on glass slides: (a) Au nanoshells with 150 nm core radius and 22 nm shell thickness, (b) Au nanoshells with 100 nm core radius and 25 nm shell thickness, and (c) Au nanoshells with 60 nm core radius and 20 nm shell thickness.

FIG. 12 shows the SERS performance of the nanoshell arrays: SERS spectrum of (a) CTAB, (b) pMA on nanoshell (150 nm core radius, 22 nm shell thickness) monolayer arrays, (c) SERS spectrum of pMA on the isolated nanoshells (150 nm core radius, 22 nm shell thickness), and (d) Empirical SERS enhancement factors of pMA adsorbed on nanoshell arrays and the isolated nanoshells.

FIG. 13 shows the SEIRA performance of the nanoshell arrays: (a) Normal IR spectrum of pure pMA and SEIRA spectrum of pMA SAMs on the nanoshell arrays, and (b) SEIRA enhancement factors of different IR modes calculated based on the experimental spectra.

### DETAILED DESCRIPTION

Disclosed herein are compositions comprising a substrate and an adsorbate. In an embodiment, the substrate comprises nanoparticles having a dielectric core and a conducting shell. In some embodiments, the nanoparticles are aggregated and the adsorbate may be any material possessing non-Raman active vibrational modes. Nanoparticle aggregates having an adsorbate of the type described herein may display surface enhanced infrared absorption (SEIRA) spectral features and such compositions are collectively referred to hereinafter as SEIRA compositions.

In an embodiment, the SEIRA composition comprises a substrate and such substrates comprise one or more nanoparticles. For example, the substrate may comprise a plurality of nanoparticles, which in some embodiments may form aggregates as described in more detail herein. The nanoparticles of this disclosure may comprise at least two layers. At least one layer is immediately adjacent to and surrounds another layer. The innermost layer is termed the core. The layer that surrounds the core is termed the shell layer. The shell layer may be metallic in nature in that it is comprised of a material that is electrically conductive such as for example a metal or metal-like material. In some embodiments, at least one shell layer readily conducts electricity. Alternatively, at least one shell layer may have a lower dielectric constant than the adjacent inner or core layer. In some embodiments, this metal or metal-like shell layer is the outermost layer. In other embodiments, the shell layer immediately adjacent to the core is not the outer most shell layer. Additional layers, such as a non-conducting layer, a conducting layer, or a sequence of such layers, such as an alternating sequence of non-conducting and conducting layers, may be bound to this shell layer. Thus, for the purposes of this disclosure the term conductor is defined by reference to the adjacent inner layer and includes any material having a lower dielectric constant than its immediately adjacent inner layer.

In an embodiment, the adjacent inner or core layer to the shell layer is a non-conducting layer. Specifically contemplated are non-conducting layers made of dielectric materials and semiconductors. Suitable dielectric materials include but are not limited to silicon dioxide, titanium dioxide, polymethyl methacrylate (PMMA), polystyrene, gold sulfide and macromolecules such as dendrimers.

In an embodiment, the nanoparticle comprises a nonconducting core layer which may be a monodisperse, spherical particle that is easily synthesized in a wide range of sizes, and has a surface that can be chemically derivatized. For example, the nonconducting layer or core material may comprise monodisperse colloidal silica. In some embodiments, the core is spherical in shape; alternatively the core may have other shapes such as cubical, cylindrical, ellipsoidal, or hemispherical. Regardless of the geometry of the core, the particles may be homogenous in size and shape.

In an embodiment, the nanoparticle comprises a conducting shell layer comprising a metallic material. Alternatively, the conducting layer comprises an organic conducting material such as polyacetylene, doped polyanaline and the like. Any metal that can conduct electricity may be suitable for use in this disclosure such as noble or coinage metals. Other examples of suitable metals include but are not limited to gold, silver, copper, platinum, palladium, lead, iron or the like and combinations thereof. Alternatively, the conducting layer comprises gold, silver or combinations thereof. Alloys or non-homogenous mixtures of such metals may also be used.

The conducting shell layers may have a thickness that ranges from approximately 1 to 100 nm. The thickness of the shell material may be selected to generate a plasmon resonance frequency. They may coat the adjacent inner layer fully and uniformly or may partially coat that layer with atomic or molecular clusters. In either embodiment, at least approximately 30% of the adjacent inner layer is coated by the conducting layer. In an embodiment, the SEIRA composition comprises a nanoparticle of the type disclosed herein whose plasmon resonance frequencies have been tuned to the mid-IR spectral range wherein the mid-IR spectral range is defined as from about 4000 cm⁻¹ to about 400 cm⁻¹ or from about 2.5 μm to about 14 μm. The tuning of the plasmon resonance frequency may be carried out by modification of the ratio of the thickness of the metal shell layer to the nonconducting inner layer, also termed the aspect ratio. By varying the reaction conditions for production of the nanoshell, the aspect ratio may be varied in a predictable and controlled way. Nanoparticles of the type disclosed herein can be constructed with metallic shell layer radius (r1) to core layer radius (r2) ratio ranging from about 1.07 to about 1.09, alternatively from about 1.12 to about 1.23, alternatively from about 1.08 to about 1.09. Such nanoparticles comprising a non-conductive inner core and an electrically conductive outer shell and tuning said particles such that they generate a plasmon resonance frequency within a user-desired spectral range are described in U.S. Pat. Nos. 6,344,272; 6,699,724; and 7,147,687 each of which are incorporated by reference herein in its entirety.

The SEIRA composition may comprise nanoparticles which are substantially spherical or elliptical in geometry. Such nanoparticles are commonly referred to as nanoshells. Alternatively, the SEIRA composition may comprise nanoparticles having other shapes/geometries such as for example nanoshell arrays, nanotriangles, or combinations thereof. Hereinafter, for simplicity, the disclosure will use the term nanoparticle or nanoshell however the other shapes/configurations and/or geometries described herein are also contemplated.

In an embodiment, the SEIRA composition comprises a substrate formed of one or more nanoparticle aggregates. The individual nanoparticles may upon contact and form associations through intermolecular forces (e.g. van der Waals forces, charge interactions) that lead to the production of nanoparticle aggregates that may function as a substrate for adsorbates described herein. The nanoparticle aggregates may comprise associations of two or more nanoparticles to form multimers (i.e. dimers, trimers, quadrumers, pentamers, etc. . . . ). In an embodiment, the nanoparticle aggregates comprise n particles where n is equal to or greater than 3, alternatively n is from about 2 to about 10, alternatively n is from about 3 to about 8. In some embodiments, the nanoparticle aggregates in the SEIRA composition comprise a mixture of multimers.

In an embodiment, the nanoparticle aggregrates comprise periodic aggregates, also termed arrays. Such periodic aggregates refer to subwavelength-structured metallic substrates that may serve as substrates that can be used to enhance both the infrared absorption and Raman scattering spectra of an adsorbate as will be described in more detail later herein. Such periodic aggregates may be further characterized as close packed structures with domain sizes ranging from about tens of microns to equal to or greater than about 200 microns. Periodic aggregates of the type disclosed herein may be prepared using any means known to one of ordinary skill in the art. One such method is described later herein. In some embodiments, the periodic aggregates may be functionalized with a modifier that can dictate the interparticle spacing of the particles in the array and/or define the local electromagnetic properties of the nanoshell array structures. In an embodiment, the modifier comprises a surfactant, alternatively, the modifier comprises cetyltrimethyl ammonium bromide (CTAB).

Aggregation of the individual nanoparticles into nanoparticle aggregates (i.e., dimers, trimers, etc. . . . ) may result in the nanoparticle aggregates having a plasmon resonance in one or more regions that differ from the plasmon resonance of any individual nanoparticle in the aggregate. For example, while an individual nanoparticle may have a plasmon resonance tuned to the near-IR an aggregate of such nanoparticles may exhibit a plasmon resonance in the mid-IR due to the presence of nanoparticle junctions that create “hot spots” which are described herein.

In an alternative embodiment, the SEIRA composition comprises one or more discrete nanoparticles in addition to or in lieu of the nanoparticle aggregates whose plasmon resonance has been tuned to the mid-IR. Such nanoparticles and methods of tuning same have been described by Oldenburg, S. J. et al. in “Infrared Extinction Properties of Gold Nanoshells” published in Applied Physics Letters (1999), Volume 75, page 2897 and Halas, N. J. in “Tuning the Optical Resonance Properties of Metallic Nanoshells” published in MRS Bulletin (2005) Volume 30, page 362, each of which is incorporated by reference herein in its entirety. Hereinafter, for simplicity, the disclosure will refer to the use of a substrate which may comprise nanoparticle aggregates and/or individual, discrete nanoparticles having a plasmon resonance in the mid-IR as described herein.

In an embodiment, the SEIRA composition comprises one or more adsorbates that are associated with the substrate (e.g., nanoparticle aggregates). The adsorbate may be any material that can associate with the substrates of this disclosure and comprises a non-Raman active vibrational mode. The adsorbate may be further characterized by the presence of features that allow for enhanced optical properties such as for example aromatic rings, lone pair electrons and the like. The adsorbate may be an organic molecule comprising aromatic rings, amines, sulfuryl groups and the like; alternatively, the adsorbate may comprise a biomolecule such as a protein, peptide or nucleic acid. Specific examples of adsorbates include without limitation compounds comprising the following functional groups: alkyl, vinyl, aromatic, alkyne, aldehyde, ketones, alcohols, phenols, amines, ethers, nitrites or combinations thereof. In an embodiment) the adsorbate comprises O-ethyl-S-[2(diisopropylamino)ethyl]methylphosphonothiolate (VX), O-Isopropyl methylphosphonofluoridate (sarin); O-Pinacolyl methylphosphonofluoridate (Soman); Ethyl N,N-dimethylphosphoramidocyanidate (Tabun); 2-azabicyclo[2.2.2]Oct-3-yl α-hydroxy-α-phenylbenzeneacetate (BZ); or combinations thereof. In an embodiment, the adsorbate may be any material whose SEIRA spectral response is chemically and/or physically responsive. For example, the adsorbate may comprise an organic molecule whose SEIRA spectral response alters as a function of alterations in pH or the adsorbate may comprise a biomolecule whose SEIRA spectral response alters upon association with a ligand.

The adsorbate may associate with the substrate through any number and type of interaction. As such, although the term adsorbate is used throughout the disclosure, a variety of mechanisms in addition to adsorption may be contemplated as mechanisms of associating the adsorbate with the substrate. For example, the adsorbate may associate with the substrate through an electrostatic interaction with the shell layer. Alternatively, the adsorbate may associate with the substrate through the formation of a chemical bond between the adsorbate and the components of the shell layer. Alternatively, the adsorbate may associate with the substrate through a plurality of interactions comprising chemical bonding, electrostatic interactions, physical interactions or combinations thereof. In an embodiment, the adsorbate comprises a functionality that allows it to form a covalent bond with a component of the shell layer of the substrate.

In an embodiment, the adsorbate is present in sufficient quantity to allow for the adsorbate to cover from about 1% to about 100% of the surface area of the substrate. Alternatively the adsorbate covers greater than about 5, 10, 15, 20, 25, 30, 35, 40, 45, 50, 55, 60, 65, 70, 75, 80, 85, 90, or 95% of the surface area of an individual nanoparticle in the substrate. In an embodiment, the adsorbate covers about 100% of the surface of an individual nanoparticle in the nanoparticle aggregate. A method for associating the adsorbate with the substrate may comprise chemically bonding the adsorbate to the substrate wherein an excess of adsorbate to substrate surface area is present in order to facilitate complete coverage of the surface area of the substrate to form the SEIRA composition. The method may further comprise additional processing of the SEIRA composition following association of the substrate with an excess of adsorbate (e.g. rinsing) so as to facilitate the removal of any adsorbate not chemically bound to the substrate. Methods of chemically bonding the adsorbate to the substrate will vary depending on the nature of the adsorbate and the type and number of bonds to be formed and may be chosen by one of ordinary skill in the art to meet the desired needs of the process.

In some embodiments, the substrate comprises more than one adsorbate. The adsorbate may be chosen to provide non-interfering optical properties over the range of the electromagnetic spectrum of interest (e.g., mid-IR). For example, the adsorbate may have more than one non-Raman active vibrational mode due to the presence of one or more functional groups with varying mid-IR absorption properties.

A method of preparing the SEIRA composition may comprise tuning the plasmon resonance of a substrate (e.g., one or more nanoparticles) to the near-IR; contacting an adsorbate molecule of the type described herein with the substrate to form an adsorbate-substrate composition; and aggregating the adsorbate-substrate composition (e.g. forming one or more nanoparticle aggregates) to form a SEIRA composition, wherein the resultant SEIRA composition has a plasmon resonance frequency tuned to the mid-IR as disclosed herein. In an alternative embodiment, a method of preparing a SEIRA composition may comprise tuning the plasmon resonance of a substrate (e.g. individual discrete nanoparticles) to the mid-IR and contacting an adsorbate molecule of the type described herein with the substrate to form a SEIRA composition. In an alternative embodiment, a method of preparing a SEIRA composition comprises tuning the plasmon resonance of a first substrate to the mid-IR; tuning the plasmon resonance of a second substrate to the near-IR; associating an adsorbate with the first and second substrates to form an adsorbate-substrate composition; and aggregating the adsorbate substrate composition to form a SEIRA composition, wherein the resultant SEIRA composition has a plasmon resonance frequency tuned to the mid-IR as disclosed herein.

In an embodiment, the SEIRA composition further comprises a medium with which the adsorbate-substrate mixture forms an association. The medium may be chosen to be highly refractive wherein a highly refractive medium is defined as a media with a dielectric constant greater than 5. For example, the medium may comprise a solid support wherein the adsorbate-substrate mixture associates with the surface of the support. Any solid support material compatible with the components of the SEIRA composition may be employed. Further, the solid support may comprise any material which is transparent in the IR. Examples of solid supports suitable for use in this disclosure include glass, silicon, alumina, or combinations thereof. In an embodiment, the solid support comprises silica and the substrates may become associated with the support through any means known to one of ordinary skill in the art. For example, the substrates may be affixed, immobilized, deposited, adhered to, or absorbed onto the solid support.

In an embodiment, the medium may comprise a liquid and the adsorbate-substrate mixture is unsupported but exists as a component in the liquid. For example, the unsupported substrate may be present in an aqueous or nonaqueous liquid or may be embedded in a matrix material which has characteristics of a liquid (e.g., gel).

The medium may be chosen by one of ordinary skill in the art to be compatible with the components of the SEIRA composition and meet the needs of the process. Further, the medium may be characterized as transparent. In an embodiment, the SEIRA composition can be deposited on an attenuated total reflectance (ATR) element such as a Si or Ge prism and then be used in solution for various solution phase measurements.

Without intending to be limited by theory, two different effects are thought to contribute to the total enhancement in SEIRA: electromagnetic and chemical effects. The electromagnetic enhancement is due to large local field intensities at the metal surface relative to the intensity of the incident wave, resulting from the excitation of surface plasmons of the metallic substrate. These local optical fields are greatly intensified in certain specific nanoparticle geometries, such as nanoscale junctions between closely adjacent nanoparticles, also known as “hot spots.” Hot spots occur naturally in random colloidal aggregates, giving rise to the extremely large SERS enhancements reported for these types of structures. Chemical enhancement more generally encompasses many interactions, such as substrate-adsorbate bond formation, charge transfer, or modifications in the electronic structure of the substrate-adsorbate complex, that modify energy levels or introduce new states that may effect the intensity or frequency of spectral features in SERS or SEIRA. Although the chemical interaction between the adsorbate molecule and metal surface may certainly contribute to the total enhancement in SEIRA spectra, it is currently believed that the electromagnetic mechanism is the dominant factor behind SEIRA enhancement. Since SEIRA relies on direct IR excitation, controlled electromagnetic enhancements of SEIRA require that the near field plasmon energy of the substrate should span the broad mid-IR chemical fingerprinting region.

In an embodiment, the substrate and adsorbate are chosen by one of ordinary skill in the art such that the substrate's plasmon resonance is tuned to enhance the IR spectra of the adsorbate. Without wishing to be limited by theory, the plasmon resonances of the substrate may provide intense, local optical-frequency fields responsible for SEIRA. Isolated solid nanoparticles at their respective plasmon resonance (˜525 nm for gold, ˜430 nm for silver) have reported enhancement factors up to 10³. Herein, the substrate may have a plasmon resonance frequency that is between a first frequency of an incident electromagnetic radiation and a second frequency of IR response from the adsorbate and that may lead to enhancements of equal to or greater than about 10⁴, alternatively 10³, alternatively 10² of the SEIRA response of the adsorbate.

Further, aggregation of the nanoparticles on a solid support as described previously herein may lead to the formation of hot spots that contribute to the large SEIRA enhancement factors. The solid supports may be chosen to facilitate the aggregation of the nanoparticle substrates and to reduce the interparticle gaps in an aggregate thereby facilitating the formation of nanoparticle junctions that result in “hot spots.”

In an embodiment, SERS spectra of the SEIRA composition may also be acquired. The SERS spectrum may be detected using any device known in the art for the acquisition of such spectra. For example, the SERS spectrum may be detected utilizing an in Via Raman microscope commercially available from Renishaw, United Kingdom. The excitation wavelength may be chosen to be compatible with the plasmon resonance of the nanoparticles described herein. As such no particular limitation is placed on the excitation wavelength which may be chosen by one of ordinary skill in the art to meet the desired application. Such SERS spectra may be used to corroborate one or more parameters evidenced by the SEIRA spectrum, identify one or more parameters different from the SEIRA spectrum parameters or both.

In an embodiment, a composition for use in determining both the SERS and SEIRA spectra of an adsorbate comprises a periodic aggregate or nanoshell array such as the type described herein.

A SEIRA composition of this disclosure may function as an all optical sensor with the ability to detect and report on the chemical composition of an environment. In such embodiments, the SEIRA composition may comprise an adsorbate having a chemically or physically responsive SEIRA spectral response. For example, the SEIRA spectral response may be altered as a function of chemical changes in the environment (e.g. changes in pH, changes in ion concentrations) or may be altered through physical changes such as for example the association of an adsorbate molecule with a component present in the environment (e.g. protein:ligand association). In some embodiments, the environment may comprise a biological medium such as for example a cell or tissue. In an embodiment, the SEIRA composition functions as a nanosensor that may be embedded in an organism whose tissues or cells are experiencing a dysfunction or disorder. The SEIRA composition may be localized to specific cellular types such as for example neoplastic cells or cells having comprised cellular functions and may provide a means of detecting alterations in the chemical composition of the environment. For example, a SEIRA composition may be introduced to a cellular environment and the mid-IR spectra of the adsorbate acquired. The SEIRA spectrum of the adsorbate may be detected by a device located in vivo in proximity to the SEIRA composition and capable of receiving and transmitting SEIRA spectral data.

For example, a method of determining the pH of an environment may comprise introducing to said environment of unknown pH a SEIRA composition of the type described herein. The SEIRA spectrum of the adsorbate in said environment may then be compared to the SEIRA spectrum of the adsorbate at one or more known pH values and the comparison used to determine or estimate the pH of the environment. In an alternative embodiment, the SEIRA spectral data acquired at known pH values may be processed (e.g. parameterized or correlated) to allow for a more facile comparison to similar SEIRA spectral data collected for samples having an unknown pH value.

In an embodiment, the data acquired (e.g., the SEIRA spectral response at a plurality of known pH values) may be parameterized to allow a user to visualize at least a portion of the spectral window of the pH-induced SEIRA spectral response as a plurality of points on a one-dimensional curve (known as a manifold) in a high dimensional vector space. Each dimension of this high dimensional space corresponds to one frequency band of the measured SEIRA spectral response. The nonlinear data points may then be fit to a plurality of linear segments (called a locally linear manifold approximation) using any number of software programs capable of providing a user-desired fit to a nonlinear data set such as for example MATLAB. Approximating the data points on the one-dimensional manifold using linear segments can be carried out employing any technique known to one of ordinary skill in the art, including for example ISOMAP which is described in Tenenbaum et al. entitled “A Global Geometric Framework for Nonlinear Dimensionality Reduction” published in Science; Volume 290; pages 2319-2322 or local linear embedding which is described by Roweis et al. entitled “Nonlinear Dimensionality Reduction by Locally Linear Embedding” published in Science; Volume 290; pages 2323-2326, both of which are incorporated by reference in their entirety. Alternatively, the measured data points along this one-dimensional manifold can be approximated locally by linear segments found through standard least-squares data fitting. For example, the nonlinear data fit may be carried out by the application of x linear segments having k breakpoints to curve z. The number and placement of the breakpoints may be chosen by one of ordinary skill in the art to provide a best fit to the nonlinear data. Given these breakpoints, linear segments can be fit to the data using standard least-squares techniques applied in the high-dimensional space. The fitting of the linear segments, the number of breakpoints, and the position of the breakpoints may be carried out using the previously mentioned software.

In an embodiment, the SEIRA spectrum of a sample of unknown pH may be recorded and then compared to the locally linear manifold approximation made of the data acquired at one or more known pH values and represented as a graph having the features previously described herein. The closest point on the locally linear manifold approximation may be located and then (since it is parameterized by pH units), the pH estimate may be read directly from the graph. Such methods are described in U.S. patent application Ser. No. 11/762,430 entitled “All Optical pH Sensor”, filed Jun. 13, 2007 and incorporated by reference herein in its entirety. Additional uses for the SEIRA compositions of this disclosure would be apparent to one of ordinary skill in the art.

The SEIRA spectrum may be acquired using any device known in the art for the acquisition of such spectra. For example, the Thermo Nicolet FTIR spectrometer. The spectra may be acquired manually, alternatively the spectra may be acquired automatically and the information conveyed to a computerized apparatus, wherein the method described herein is implemented in software on a general purpose computer or other computerized component having a processor, user interface, microprocessor, memory, and other associated hardware and operating software. Software implementing the method may be stored in tangible media and/or may be resident in memory, for example, on a computer. Likewise, the spectral data acquired may be stored in a tangible media, computer memory, hardcopy such as a paper printout, or other storage device.

The following references provide background information and are each incorporated herein by reference, except to the extent that they define terms differently than those terms are defined herein:
(1) Kneipp, K.; Wang, Y.; Kneipp, H.; Perelman, L. T.; Itzkan, I.; Dasari, R. R.; Feld, M. S. Phys. Rev. Lett. 1997, 78, 1667.
(2) Nie, S.; Emory, S. R. Science 1997, 275, 1102.
(3) Crookell, A.; Fleischmann, M.; Hanniet, M.; Hendra, P. J. Chem. Phys. Lett. 1988, 149, 123.
(4) Chase, D. B.; Parkinson, B. A. Appl. Spectrosc. 1988, 42, 1186.
(5) Angel, S. M.; Katz, L. F.; Archibald, D. D.; Honigs, D. E. Appl. Spectrosc. 1989, 43, 367.
(6) Hartstein, A.; Kirtley, J. R.; Tsang, J. C. Phys. Rev. Lett. 1980, 45, 201.
(7) Jeanmaire, D. L.; Van Duyne, R. P. J. Elecfroanal. Chem. 1977, 84, 1.
(8) Moskovits, M. Rev. Mod. Phys. 1985, 57, 783.
(9) Osawa, M. Near-field optics and surface plasmon polaritons Topics Appl. Phys. 2001, 81, 163.
(10) Genov, D. A.; Sarychev, A. K.; Shalaev, V. M.; Wei, A. Nano Lett. 2004, 4, 153.
(11) Li, K. R.; Stockman, M. I.; Bergman, D. J. Phys. Rev. Lett. 2003, 91, Art. No. 227402.
(12) Michaels, A. M.; Jiang, J.; Brus, L. E. J. Phys. Chem. B 2000, 104, 11965.
(13) Michaels, A. M.; Nirmal, M.; Brus, L. E. J. Am. Chem. Soc. 1999, 121, 9932.
(14) Al-Rawashdeh, N.; Foss, C. A. Nanostruct Mater. 1997, 9, 383.
(15) Sato, S.; Suzuki, T. Appl. Spectrosc. 1997, 51, 1170.
(16) Makino, N.; Mukai, K.; Kataoka, Y. Appl. Spectrosc. 1997, 51, 1460.
(17) Osawa, M.; Yoshii, K. Appl Spectrosc. 1997, 51, 512.
(18) Kellner, R.; Mizaikoff, B.; Jakusch, M.; Wanzenbock, H. D.; Weissenbacher, N. Appl Spectrosc. 1997, 51, 495.
(19) Johnson, S. A.; Pham, N.-H.; Novick, V. J.; Maroni, V. A. Appl. Spectrosc. 1997, 51, 1423
(20) Osawa, M.; Ataka, K.; Yoshii, K.; Nishikawa, Y. Appl. Spectrosc. 1993, 47, 1497.
(21) Johnson, E.; Aroca, R. J. Phys. Chem. 1995, 99, 9325.
(22) Roesler, A.; Korte, E.-H. Appl. Spectrosc. 1995, 51, 902.
(23) Merklin, G. T.; Griffiths, P. R. Langmuir 1997, 13, 6159.
(24) Badilescu, S.; Ashrit, P. V.; Truong, V.; Badilescu, I. I. Appl. Spectrosc. 1989, 43, 549.
(25) Heaps, D. A.; Griffiths, P. R. Vib. Spectrosc 2006, 42, 45.
(26) Jensen, T. R.; Van Duyne, R. P.; Johnson, S. A.; Maroni, V. A. Appl. Spectrosc. 2000, 54, 371.
(27) Rodriguez, K. R.; Shah, S.; M., W. S.; Teeters-Kenedy, S.; Coe, J. V. J. Chem. Phys. 2004, 121, 8671.
(28) Oldenburg, S. J.; Averitt, R. D.; Westeott, S. L.; Halas, N. J. Chem. Phys. Lett. 1998, 288, 243.
(29) Prodan, E.; Nordlander, P. Nano Letters 2003, 3, 543,
(30) Oldenburg, S. J.; Jackson, J. B.; Westcott, S. L.; Halas, N. J. Applied physics letters 1999, 75, 2897.
(31) Halas, N. J. MRS Bulletin 2005, 30, 362.
(32) Oubre, C.; Nordlander, P. J. Phys. Chem. B 2005, 109, 10042.
(33) Nordlander, P.; Oubre, C.; Prodan, E.; Li, K.; Stockman, M. I. Nano Lett. 2004, 4, 899.
(34) Brandl, D. W.; Oubre, C.; Nordlander, P. J. Chem. Phys. 2005, 123, 024701.
(35) Wang, H.; Levin, C. S.; Halas, N. J. J. Am. Chem. Soc. 2005, 127, 14992.
(36) Wang, H.; Halas, N. J. Nano Letters 2006, 6, 2945.
(37) Tam, F.; Moran, C. E.; Halas, N. J. Journal of Physical Chemistry B 2004, 108, 17290.
(38) Lal, S.; Grady, N.; Goodrich, G. P.; Halas, N. J. Nano Letters 2006, 6, 2338.
(39) Prodan, E.; Nordlander, P.; Halas, N. J. Chemical Physics Letters 2003, 368, 94.
(40) Priebe, A.; Sinther, M.; Fashold, G.; Pucci, A. J. Chem. Phys. 2003, 119, 4887.
(41) Krauth, O.; Fahsold, G.; Magg, N.; Pucci, A. J. Chem. Phys. 2000, 113, 6330.
(42) Krauth, O.; Fahsold, G.; Pucci, A. J. Chem. Phys. 1999, 110, 3113.
(43) Heaps, D. A.; Griffiths, P. R. Vib. Spectrosc. 2006, 41, 221.
(44) Osawa, M.; Matsuda, N.; Yoshii, K.; Uchida, I. J. Phys. Chem. 1994, 98, 12702.
(45) McNutt, A.; Haq, S.; Raval, R. Surf Sci. 2003, 531, 131.
(46) Mohri, N.; Matsushita, S.; Inoue, M.; Yoshikawa, K. Langmuir 1998, 14, 2343.
(47) W. L. Barnes, A. Dereux, T. W. Ebbesen, Nature 2003, 424, 824.
(48) S. A. Maier, M. L. Brongersma, P. G. Kik, S. Meltzer, A. A. G. Requicha, H. A. Atwater, Adv. Mater. 2001, 13, 1501.
(49) S. A. Maier, H. A. Atwater, J. Appl. Phys. 2005, 98, 011101.
(50) E. Ozbay, Science 2006, 311, 189.
(51) J. B. Pendry, Phys. Rev. Lett. 2000, 85, 3966.
(52) T. W. Ebbesen, H. J. Lezec, H. F. Ghaemi, T. Thio, P. A. Wolff, Nature 1998, 391, 667
(53) Y. W. C. Cao, R. C. Jin, C. A. Mirkin, Science 2002, 297, 1536.
(54) R. Elghanian, J. J. Storhoff, R. C. Mucic, R. L. Letsinger, C. A. Mirkin, Science 1997, 277, 1078.
(55) M. Osawa, Bull. Chem. Soc. Jpn. 1997, 70, 2861.
(56) K. Aslan, I. Gryczynski, J. Malicka, E. Matveeva, J. R. Lakowicz, C. D. Geddes, Curr. Opin. Biotechnol. 2005, 16, 55,
(57) G. Schneider, G. Decher, N. Nerambourg, R. Praho, M. H. V. Werts, M. Blanchard-Desce, Nano Lett. 2006, 6, 530.
(58) F. Tam, G. P. Goodrich, B. R. Johnson, N. J. Halas, Nano Lett. 2007, 7, 496.
(59) U. Kreibig, M. Vollmer, Optical Properties of Metal Clusters, Springer-Verlag, Berlin, Germany, 1995.
(60) B. Schrader, Infrared and Raman Spectroscopy: Methods and Applications, Weinheim, New York, 1995.
(61) H. X. Xu, E. J. Bjemeld, M. Kall, L. Borjesson, Phys. Rev. Lett. 1999, 83, 4357.
(62) D. A. Genov, A. K. Sarychev, V. M. Shalaev, A. Wei, Nano Lett. 2004, 4, 153.
(63) S. J. Lee, A. R. Morrill, M. Moskovits, J. Am. Chem. Soc. 2006, 128, 2200.
(64) E. Prodan, C. Radloff, N. J. Halas, P. Nordlander, Science 2003, 302, 419.
(65) H. Wang, D. W. Brandl, P. Nordlander, N. J. Halas, Ace. Chem. Res. 2007, 40, 53.
(66) E. Prodan, A. Lee, P. Nordlander, Chemical Physics Letters 2002, 360, 325.
(67) J. B. Jackson, N. J. Halas, Proc. Natl. Acad. Sci. USA 2004, 101, 17930.
(68) A. J. Haes, C. L. Haynes, A. D. McFarland, G. C. Schatz, R. R. Van Duyne, S. L. Zou, MRS Bulletin 2005, 30, 368.
(69) E. Prodan, P. Nordlander, J. Chem. Phys. 2004, 120, 5444.
(70) C. E. Talley, J. B. Jackson, C. Oubre, N. K. Grady, C. W. Hollars, S. M. Lane, T. R. Huser, P. Nordlander, N. J. Halas, Nano Lett. 2005, 5, 1569.
(71) B. Nikoobakht, Z. L. Wang, M. A. El-Sayed, J. Phys. Chem. B 2000, 104, 8635.
(72) C. J. Orendorff, P. L. Hankins, C. J. Murphy, Langmuir 2005, 21, 2022.
(73) D. W. Brandl, N. A. Mirin, P. Nordlander, J. Phys. Chem. B 2006, 110, 12302.
(74) C. Oubre, P. Nordlander, J. Phys. Chem. B 2004, 108, 17740.
(75) P. Nordlander, private communication.
(76) D. A. Heaps, P. R. Griffiths, Vibrational Spectroscopy 2006, 42, 45.
(77) N. Goutev, M. Futamata, Appl. Spec. 2003, 57, 506.
(78) M. Osawa, N. Matsuda, K. Yoshii, 1. Uchida, J. Phys. Chem. 1994, 98, 12702-12707.
(79) Q. Zhou, X. Li, Q. Fan, X. Zhang, J. Zheng, Angew. Chem. Int. Ed. 2006, 45, 3970-3973
(80) L. Cao, P. Diao, L. Tong, T. Zhu, and Z. Liu, ChemPhysChem. 2005, 6, 913-918

### EXAMPLES

The various embodiments having been described, the following examples are given as particular embodiments and to demonstrate the practice and advantages thereof. It is understood that the examples are given by way of illustration and are not intended to limit the specification or the claims in any manner.

Examples 1-4 illustrate the use of SEIRA compositions comprising an absorbate and a nanoparticle aggregate.

Example 5 describes methods of preparing periodic aggregates.

Example 6 describes the use of periodic aggregates as substrates for SERS-SEIRA compositions.

### Example 1

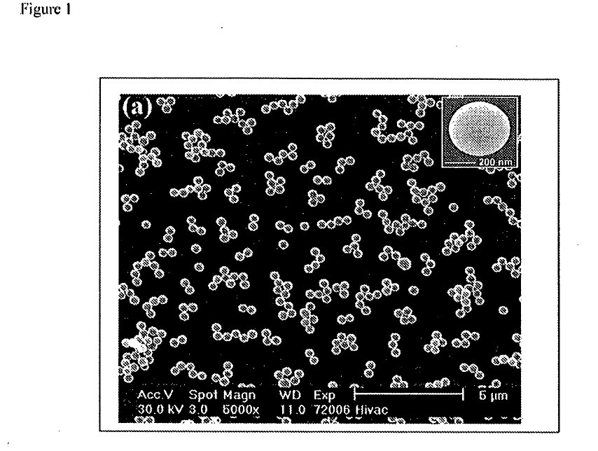

The use of Au nanoshells as the nanoparticle substrates for a SEIRA composition was investigated. Au nanoshells of dimensions [r1, r2]=[190, 210] nm with a 6.2% polydispersity in total nanoshell size distribution were fabricated using an electroless deposition method previously described in an article entitled “Nanoengineering of Optical Resonances” by Oldenburg, S. J. et al. published in Chem. Phys. Lett. (1998) Volume 288, page 243 and in an article entitled “Structural Tunability of Plasmon Resonances” by Prodan, E. and Nordlander, P. published in Nano. Letters (2003) Volume 3, page 543 each of which is incorporated by reference in its entirety. The particle size was determined by quantitative comparison of the UV-visible extinction spectrum with Mie scattering theory, with independent verification using scanning electron microscopy (SEM). Once fabricated, the nanoshells were dispersed on poly(4-vinylpyridine) functionalized clean glass support by solvent evaporation. The glass supports were cleaned using piranha (70% H₂SO₄, 30% H₂O₂) solution followed by copious rinsing with Milli-Q water (Millipore). FIG. 1 shows a representative SEM image of a nanoshell aggregate substrate with a morphology typical of the substrates used in all of the following experiments. As evident in this image, the film has both individual nanoshells as well as large distribution of nanoshell aggregate ‘n-mers’ from dimers, trimers and quadrumers to much larger, higher order aggregate structures.

### Example 2

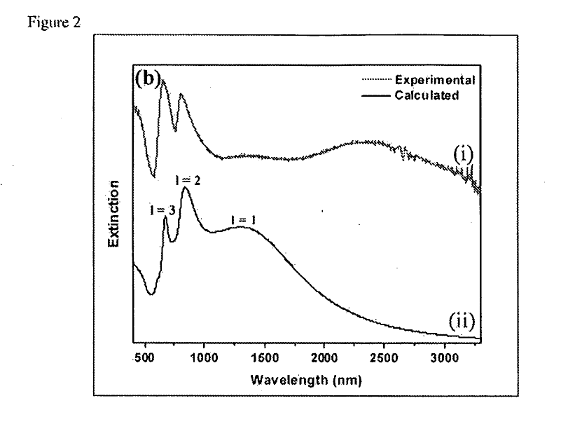

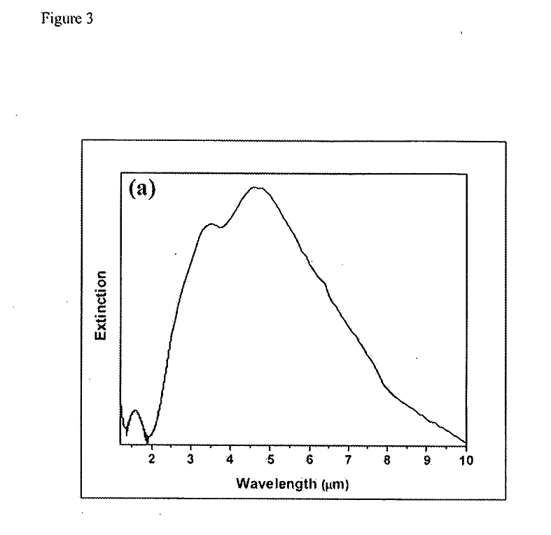

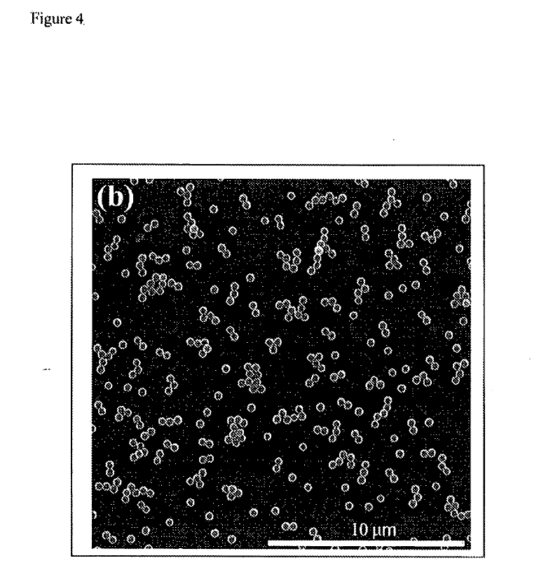

Optical features of the nanoparticles prepared in Example I were determined. Specifically, far field extinction spectra of nanoshell film on glass were recorded using a Cary 5000 UV-vis-NIR spectrophotometer using a blank poly(4-vinylpyridine) functionalized glass support as a reference. The experimental and calculated visible-near IR extinction spectra of a typical nanoshell aggregate substrate are shown in FIGS. 2(i) and 2(ii) respectively. Referring to FIG. 2(i), a strong, broad band in the IR and sharper bands in the shorter wavelength visible region were clearly observed. FIG. 2(ii) shows the extinction spectrum calculated using Mie theory of an individual nanoshell. A nanoshell dimension of [r1, r2]=[190,205] nm provided the best correspondence to the experimental spectrum, where an effective medium of ∈=1.3 was used to model the effect of the glass support. The short wavelength (λ<1600 mm) peaks in the experimental spectrum have been assigned to the dipole (1=1), quadrupole (1=2), and octupole (1=3) of the individual nanoshell plasmon response. These peaks are clearly identifiable at wavelengths of 1369 nm, 798 nm, and 647 nm, respectively. In addition to the spectral features attributable to the individual nanoshells, a broad long wavelength peak with a maximum at a wavelength of 2.4 microns is present only in the extinction spectrum of the aggregated nanoshells. It is this spectral feature that we attributed to the junction plasmons, the hot spots, of the nanoshell aggregate film on glass. For these nanoshell aggregate films, we anticipated that wavelengths corresponding to the bandwidth of the 2.4 micron aggregate feature would be enhanced in SEIRA, corresponding approximately to 3500-5000 cm⁻¹ in the molecular spectrum. It was generally seen that near field spectra, i.e., the energy range relevant for surface enhanced spectroscopies, are often redshifted relative to far field spectra, an effect advantageous for further expanding the available SEIRA bandwidth into the low wavenumber range of the chemical fingerprinting region. Another important effect that results in the redshifting of plasmon energies is the presence of a highly refractive embedding medium or support. For SEIRA, silicon is an ideal support imparting high transparency across the mid-IR with a refractive index of n=3.432 in this wavelength range. FIG. 3 shows a representative extinction spectrum of nanoshell aggregates deposited on silicon support, while FIG. 4 is an SEM image of the deposited aggregate structures. Based on the far field extinction spectra (FIG. 2(i)), an approximate wavelength range for the nanoshell/Si-supported substrates may be anticipated to be nominally 2.5-8 microns in wavelength (1250-4000 cm⁻¹) spanning a large portion of the chemical fingerprinting range.

### Example 3

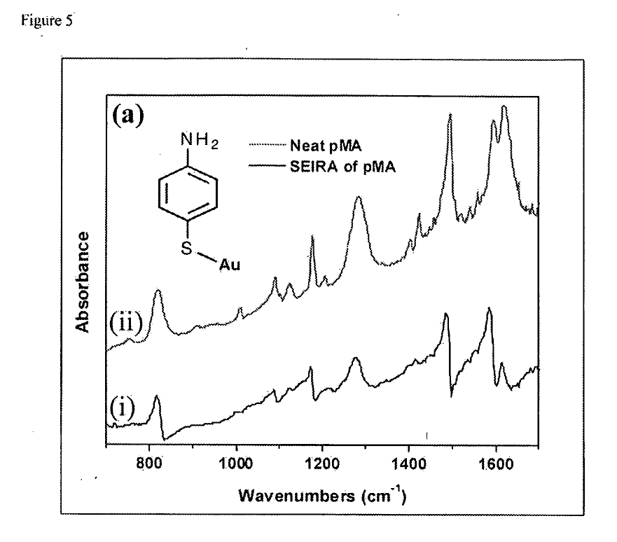

A SEIRA composition was prepared and the SEIRA spectra acquired. Specifically, to perform SEIRA on adsorbed molecules, nanoshell aggregate films on silicon supports were soaked overnight in 1 mM solution of analyte molecule (ethanolic para-mercaptoaniline (pMA) and aqueous adenine solution (pH=5.3)) followed by copious rinsing with ethanol. Unpolarized IR spectroscopy measurements were performed using transmission geometry on a FTIR spectrometer (Nexus 670, Thermo Nicolet) equipped with a liquid nitrogen cooled mercury-cadmium-tellurium (MCT) detector. FIG. 5(i) shows a characteristic transmission SEIRA spectrum of pMA obtained using a nanoparticle substrate of the type described herein. Conventional IR spectra of neat pMA dispersed in a KBr pellet is shown in FIG. 5(ii) (Nexus 670, Thermo Nicolet). For the SEIRA spectrum of FIG. 5(i) it is immediately apparent that excellent signal-to-noise is obtainable using the nanoparticle substrates described herein. Moreover, strong molecular signals are observed over a broad spectral range of 700 to 1700 cm⁻¹ for pMA, indicated that the mid-IR enhancements extend somewhat further into the long-wavelength region of the infrared than can be inferred solely by the far field extinction spectrum of FIG. 3. Qualitatively, the observed enhancements appear to be relatively uniform across this broad spectral range.

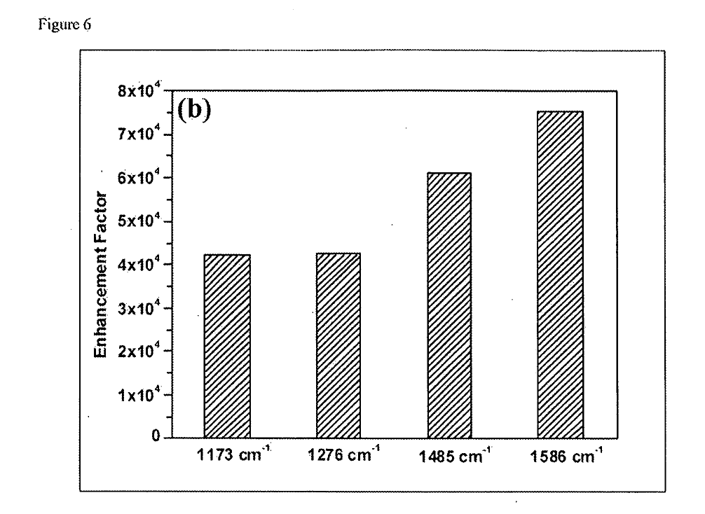

The SEIRA spectrum of pMA in FIG. 5(i) displays several important distinctions with respect to the accompanying bulk IR spectrum of FIG. 5(ii). The numerous spectral features of the SEIRA spectrum all show the highly asymmetric, Fano-type line shape characteristic of SEIRA. The extent of band asymmetry has been observed to correlate with greater enhancement factors for substrates consisting of coalescent rather than dispersed particles. Hence, the observed strong asymmetry of the peak shapes in our SEIRA spectra is attributed to the very small interparticle gaps of the nanoshell aggregate film substrate, which would give rise to mid-IR “hot spots.” Moreover, due to the excellent signal-to-noise easily obtained across the IR spectrum with these substrates, we anticipated that these substrates also give rise to large SEIRA enhancement factors. Empirical SEIRA signal enhancement factors were determined by comparing the ratio of the intensity of several of the major IR modes of pMA observable in SEIRA to their corresponding unenhanced IR absorption signals obtained from neat pMA films of known thickness (FIG. 6, discussed in greater detail below).

A comparison of the peak maxima in the SEIRA and the bulk IR spectra show both spectral shifts and intensity differences. The IR band assignments of bulk pMA were made on the basis of previous values reported and are listed in Table 1.

TABLE 1

| Bulk IR | SEIRA | Band assignment |
|---|---|---|
| 822 | | πCH (b₁) |
| | 817 | πCH (a₂) |
| 1090 | 1085 | νCS (a₁) |
| 1124 | | δCH (b₂) |
| 1177 | 1172 | δCH (a₁) |
| 1285 | 1275 | νCH (a₁) |
| 1423 | | νCC + δCH (b₂) |
| 1497 | 1485 | νCC + δCH (a₁) |
| 1597 | 1585 | νCC (a₁) |
| 1621 | 1614 | δNH |

It is evident that certain specific peaks appearing in the bulk IR spectra are absent in the SEIRA spectra, most specifically the b1 and b2 modes. Since this is most likely due to the orientation dependence of the SEIRA selection rules, it can be inferred from this observation that the pMA adsorbate molecules are oriented in an upright manner on the nanoparticle surfaces, consistent with previous spectroscopic measurements on this molecule.

### Example 3

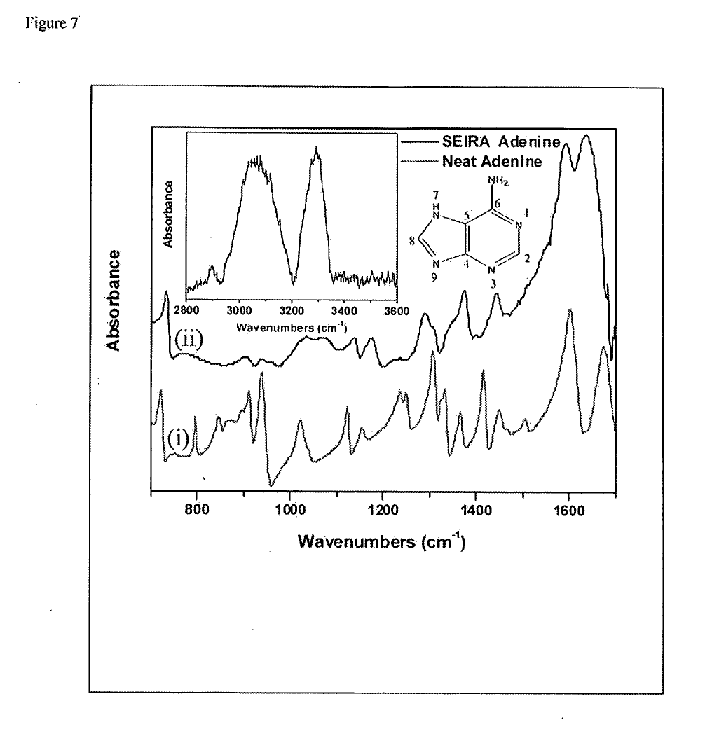

The use of nanoshell aggregate films on Si to produce SEIRA spectra was further investigated. Specifically, SEIRA compositions were prepared as described in Examples 1 and 2 with the exception that the adsorbate molecule was the nucleic acid adenine. SEIRA spectra of this composition are shown in FIG. 7 (ii). Comparison of the SEIRA spectra, FIG. 7 (ii), with the corresponding normal IR spectra of adenine, FIG. 7 (i), shows the large spectral range of SEIRA enhancement provided by the substrates. The SEIRA spectra are dominated by the symmetric NH₂ scissor mode at 1640 cm⁻¹. The presence of this strong bending mode may rule out a flat orientation of the exocyclic amino group of adenine on the nanoshell surfaces. Other vibrational modes of this group are the symmetric and antisymmetric NH₂ stretch modes that appear in the high wavenumber region, at 3296 and 3355 cm⁻¹ respectively, in the normal IR spectrum. The FIG. 7 inset shows the SEIRA spectra of adenine in the high wavenumber region (2800-3600 cm⁻¹). The absence of the NH₂ antisymmetric stretch and the presence of NH₂ symmetric stretch at 3290 cm⁻¹ in the SEIRA spectra, FIG. 7 (ii), likely indicates that the NH₂ group may be oriented upright relative to the substrate surface. Various in-plane ring modes can be observed in the SEIRA spectrum, FIG. 7 (ii), at 1596, 1443, 1377, 1344, 1290 cm⁻¹. The aromatic C—H stretch (νC₈—H, νC₂—H) is also seen in the high wavenumber region, at 3064 cm⁻¹. The presence of these ring modes strongly suggest the ring plane of adenine is not lying flat but is inclined from the surface with the C₆—NH₂ bond aligned normal to the surface.

### Example 4

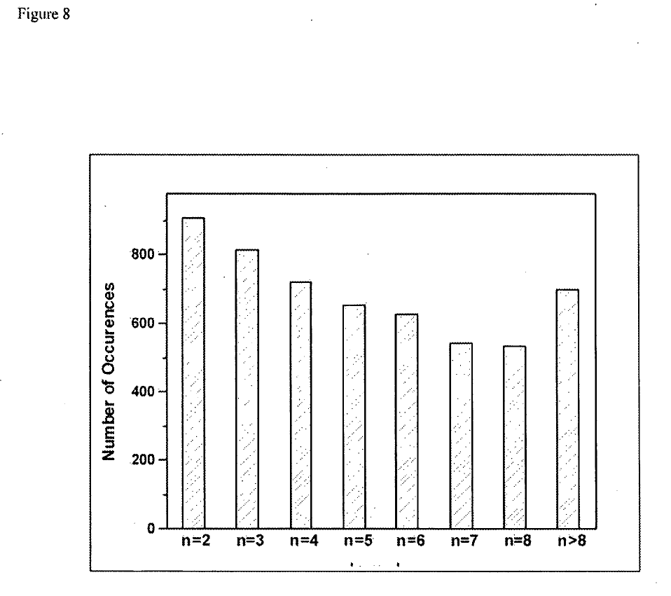

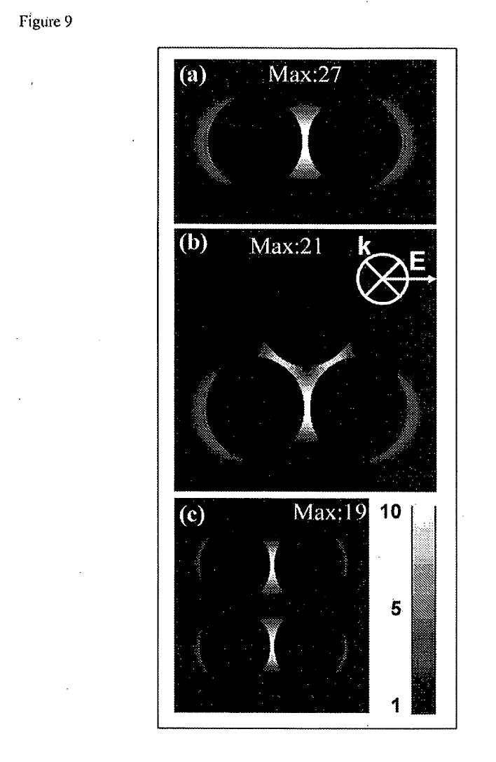

SEIRA signal enhancement factors for the sample from Example 2 were calculated. Specifically, SEIRA signal enhancement factors were determined by comparing the ratio of the intensity of several of the IR modes of pMA observable in SEIRA to their corresponding unenhanced IR spectra obtained from neat pMA films of known thickness and are shown in FIG. 6. To obtain values that realistically represent the substrate's SEIRA enhancement factors, both SEIRA and normal IR intensities must be normalized to the best estimate of the number of molecules being probed in each geometry. First, the aggregation statistics of nanoshells on silicon were analyzed using SEM images and particle counting statistics. The histogram of the number distribution of the various ‘n-mers’ present in our SEIRA substrate is given in FIG. 8. A total representative area of 0.31 mm² of the SEIRA substrate was imaged to obtain the particle counts, number density, and relative abundance of the various ‘n-mers’ that had form randomly on a SEIRA substrate. To estimate the SEIRA sensitive ‘hot spot’ area, we analyzed the local electromagnetic response of nanoshell aggregates, focusing on the interparticle regions where the local B field was more than ten times stronger than the incident E field. Finite difference time domain (FDTD) simulations were performed for nanoshell dimers, trimers and quadrumers. In these simulations to avoid underestimating the hotspot area we use a larger interparticle gap of 20 nm than what is observed in the images of our nanoshell aggregates. Since the enhancement is scaled per molecule, an underestimate of the hot spot areas would underestimate the number of molecules per hot spot, thus overestimating the enhancement. Referring to FIG. 9, FDTD simulated local field enhancements for a (a) dimer, (b) trimer and (c) quadrumer. Each nanoshell has a dimension of [190,210] nm with inter-particle separation of 20 nm. The gold nanoshell with a silica dielectric core of ∈=2.04 is surrounded by vacuum. The incident direction and polarization of light are illustrated in the figure along with the scale bar for near field enhancements. In each local field enhancement panel, all pixels with a field enhancement factor greater than 10 are colored white, indicating the hot spot area used for SEIRA enhancement factor calculation. The maximum of the local field for each simulated case is quoted in the figure. The calculated hot spot size for dimer, trimer, and quadrumer are approximately equal to 3.1×10⁴, 3.2×10⁴, 6.2×10⁴ nm², respectively.

To extend this analysis further to larger aggregates, we assumed that the hot spot area of a pentamer is approximately equal to that of a quadrumer, a hexamer aggregate hot spot area to be nominally three times that of a dimer, a heptamer hot spot area to be roughly equivalent to that of a hexamer, and an octamer hot spot area to be approximately double that of a quadrumer. The total number of pMA molecules in the aggregate being probed was then estimated by using the total hot spot areas contributed by the individual ‘n-mers’, the number density of the individual ‘n-mers’, their relative abundance in the experimental films as obtained by statistical analysis of the SEM images, and the reported footprint of the pMA molecule (0.3 nm²). As shown in FIG. 3(b), the empirical enhancement factors for various observed SEIRA vibrational modes of pMA on a nanoshell aggregate film are estimated to be in the 10⁴ range for all modes evaluated, varying only by a factor of two. Also by this analysis, as seen in FIG. 6, the enhancement factors decrease with decreasing wavenumber (increasing wavelength), consistent with our previous evaluation that the low-wavenumber modes of the SEIRA spectra are enhanced by the trailing long wavelength tail of the nanoshell aggregate plasmon resonance.

Based on the results of the foregoing experiments, we have shown that IR-resonant nanoshell aggregate films on Si are excellent supports for SEIRA, allowing us to obtain high quality SEIRA spectra of pMA and adenine across a broad 700-3300 cm⁻¹ IR range of the chemical fingerprinting region. The SEIRA spectra obtained show numerous vibrational modes corresponding to the known IR spectra of the molecule. Enhancement factors in the 10⁴ range are achievable using these substrates. From these results, it is clear that tuning the plasmon resonance into the mid-IR using infrared resonant nanoshells in aggregate topologies yields high performance SEIRA substrates, opening new opportunities for the development of SEIRA as a reliable and highly useful spectroscopic technique for numerous applications.

### Example 5

The Au nanoshells used in the present studies were fabricated following a previously reported wet chemistry method. The as-fabricated nanoshells were further purified by dialysis. In a typical procedure, 40 mL of nanoshell aqueous solution was transferred into a regenerated cellulose membrane dialysis bag (Spectra-Por, 6-8k MWCO). The bag was then suspended in a reservoir of Milli-Q water (Millipore, Billerica, Mass.) and gently stirred overnight. The dialyzed nanoshells were centrifuged and redispersed in 25 mM CTAB (Sigma-Aldrich) aqueous solution for 1 h. The CTAB-capped nanoshells were then centrifuged and redispersed in Milli-Q water to form colloidal solutions with desired particle concentrations. The assembly of the nanoshells into close-packed arrays was accomplished by depositing a droplet of the colloidal solutions (40 μL) onto a substrate surface (silicon wafer, glass slide, ITO glass, or TEM grid), and allowing it dry undisturbed under ambient conditions. The pattern morphologies of the nanoshell arrays were dependent on the particle concentration of the nanoshell solutions. At very low particle concentrations, only isolated small monolayer domains of arrays with short-range order could be formed on the substrates. Increasing the particle concentration resulted in an increase in the domain size as the initially separated domains began to coalesce with each other, forming continuous long-range-ordered monolayers. The optimum concentration for the fabrication of long-range-ordered monolayer arrays is 2.40×10⁹ particles mL-1 for the nanoshells with inner and outer radii of [R1,R2][150,172] nm. Further increase in the particle concentration resulted in the formation of double layer, triple layer, and eventually multilayer arrays. The submonolayers of isolated nanoshells were prepared by immobilizing the nanoshells onto poly(4-vinylpyridine)-functionalized glass following a previously reported protocol.

Optical extinction spectra were obtained using a Cary 5000 UV/Vis/NIR spectrophotometer. SEM measurements were performed on a Phillips FEI XL-30 environmental scanning electron microscope. TEM images were obtained using JEOL JEM-2010 transmission electron microscope. The samples for SERS and SEIRA measurements were prepared by evaporating 10 μL of a 20 μM solution of pMA in ethanol on the surface of the nanoshell arrays or isolated nanoshells. Raman spectra were obtained with a Renishaw micro-Raman spectrometer using a 785 nm excitation laser (250 mW), line-focus mode (beam size 4 μm×60 μm), 50× objective, 0.05% laser power, and 10 sec acquisition time. The laser power focused on the samples was measured to be 0.035 mW when the 50× objective and 0.05% laser power were used. SEIRA measurements were performed using an FTIR microspcope (Nexus 670, Thermo Nicolet) equipped with a liquid nitrogen cooled MCT (HgCdTe) detector. The SEIRA spectra were obtained from the coaddition of 256 scans with 4 cm-1 resolution under reflection mode.

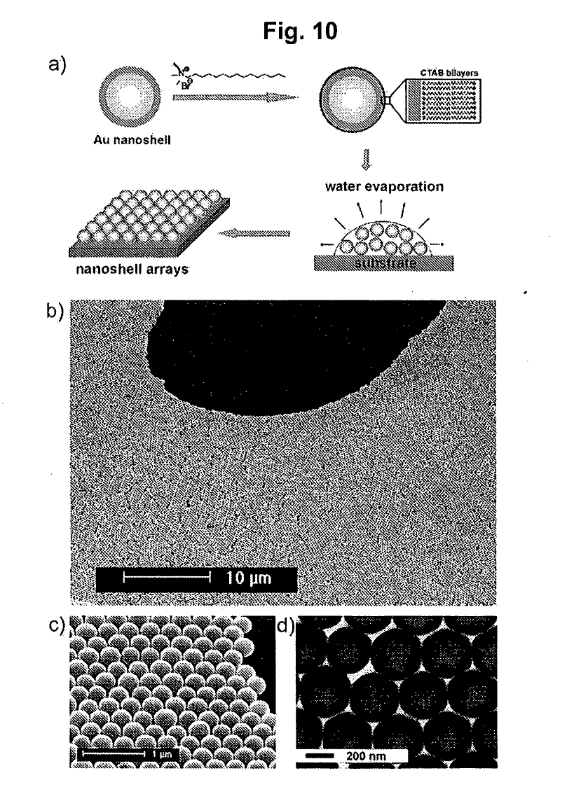

The major steps involved in the fabrication of Au nanoshell arrays are illustrated schematically in FIG. 10. Au nanoshells were fabricated following a previously reported seed-mediated electroless plating method, then purified by dialysis. The dialyzed nanoshells were functionalized with the surfactant cetyltrimethyl ammonium bromide (CTAB), and subsequently redispersed in water to form colloidal solutions with desired particle concentrations. Applying droplets of nanoshell solution to a substrate and allowing the solvent to evaporate under ambient conditions resulted in the formation of hexagonally packed nanoshell arrays, which maintain an interparticle spacing established by the bilayers of CTAB that surround each nanoshell as the interparticle spacer.

The nanoshells organize into hexagonally close-packed (hcp) structures with typical domain sizes ranging from several tens of microns to over two hundred microns (FIGS. 10c-d). CTAB functions in both in the self-assembly of these arrays, as well as in defining the local electromagnetic properties of the nanoshell array structures. The CTAB molecules form bilayer structures on the surface of Au nanoparticles, resulting in a net positive charge on the nanoparticle surfaces, and providing a net repulsive interaction between the nanoparticles to prevent random disordered aggregation during solvent evaporation. Control experiments using unfunctionalized nanoshells only resulted in the formation of disordered aggregates. The CTAB bilayers also define the spacing between neighboring nanoshells, and result in an average interparticle spacing determined to be ˜8 nm, consistent with the reported 4.4 nm thickness of a CTAB bilayer. These sub-10 nm gaps are instrumental for inducing the strong plasmon coupling that result in the specific electromagnetic properties of this array geometry.

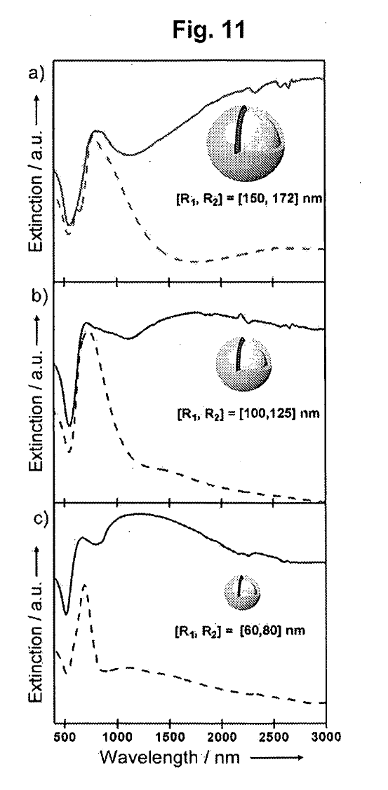

In FIG. 11, we directly compared the optical extinction spectra of nanoshell arrays to the spectra of the isolated and dispersed constituent nanoshells. These measurements were performed on nanoshell monolayer arrays formed on glass slides using unpolarized light at normal incidence. Nanoshell arrays possess two distinct plasmon resonances: a narrow visible or near infrared band at frequencies corresponding closely to those of the isolated nanoshell plasmons, and in addition, a broad feature extending from the near infrared well into the mid infrared region of the spectrum. The two plasmon bands observed for the nanoshell arrays arise from the plasmon interactions between the neighboring nanoshells in the arrays. How the individual nanoshell plasmons interact with each other to form hybridized nanoshell array plasmons can be understood by applying the Plasmon Hybridization model to multinanoparticle systems. When nanoshells are close-packed into an array structure, the dipolar plasmons of the individual nanoshells strongly intermix, forming a hybridized plasmon band, evolved from the dipolar plasmon mode, which disperses strongly to lower energies, corresponding to infrared wavelengths. The individual nanoshell quadrupole resonances, on the other hand, also intermix but only weakly, and do not disperse upon hybridization, giving rise to a plasmon band in the near infrared that appears quite similar in both wavelength and lineshape to the dipole plasmon of the individual nanoshell particles.

In addition to the new features arising in the far-field extinction spectra, the interparticle plasmon coupling in the nanoshell arrays produces intense near-field enhancements at the junctions between neighboring nanoshells, creating uniform periodic densities of hot spots for surface-enhanced spectroscopies. Theoretical simulations of the near-field properties of nanoshell arrays using Finite Difference Time Domain (FDTD) method indicate that the localized field enhancements (|E|/|E0|) inside interparticle junctions are approximately 30 both in the near infrared and over a broad range (˜2-8 microns in wavelength) in the mid infrared. Such large field enhancements both in near infrared and mid infrared are achievable only when the interparticle spacing is within the sub 10 nm range. For comparison, isolated nanoshells provide much weaker field enhancements, with maximum enhancements of approximately 5 for nanoshell plasmons in the near infrared and negligible field enhancements in the mid infrared. The nanoshell array structure turns out to be suited as an integrated SERS-SEIRA substrate, providing hot spots in the interparticle junctions that enhance both SERS at near infrared wavelengths and SEIRA at mid-IR wavelengths. It is this property that enables the observation of large, reproducible SERS and SEIRA enhancements on the same substrate.

### Example 6

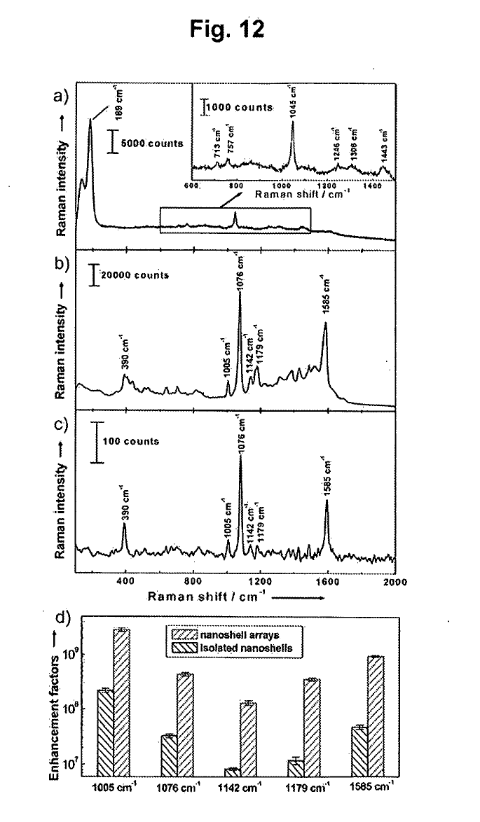

The nanoshell arrays were evaluated as SERS-SEIRA substrates using a nonresonant adsorbate molecule, para-mercaptoaniline (pMA). pMA was chosen for spectroscopic quantification on these substrates because it displaces CTAB on Au surfaces and is known to form self-assembled monolayers (SAMs) on Au surfaces with a known packing density. FIG. 12a shows the SERS spectrum of CTAB (λexc=785 nm) on the surface of the as-fabricated nanoshell arrays, showing a strong characteristic feature at 189 cm⁻¹ corresponding to the Au—Br mode. Upon complete displacement of the CTAB molecules, Au—Br mode and all the SERS modes of CTAB disappear while SERS modes of pMA and the Au—S bond at 390 cm⁻¹ become evident in the SERS spectrum (FIG. 12b), indicating the formation of saturated SAMs of pMA on the nanoshell array surfaces (see detailed peak assignments in Table S1). The SERS spectra of pMA on the nanoshell arrays are highly reproducible at different sites on a substrate with a standard deviation of less than 10%. In comparison, the SERS spectrum of saturated pMA SAMs on the surface of isolated nanoshells is also shown in FIG. 12c. Empirical signal enhancement factors were determined by comparing ratios of the intensity of SERS modes to the corresponding unenhanced signals from neat pMA films of known thickness. Both the SERS and normal Raman intensities are normalized by the number of molecules being probed. As presented in FIG. 12d, the empirical enhancement factors of pMA on the nanoshell arrays are on the order of 10⁸-10⁹, 10 to 20 times larger than what is achievable on isolated nanoshells. The SERS enhancements obtained on these nanoshell arrays are the same order of magnitude as those achieved on solid Au nanosphere arrays. These measurements represent the overall array response, not the localized enhancements inside the interparticle junctions. FDTD calculations for arrays of smooth nanoshells show that the maximum local (|E|/|E₀|) enhancement factor in the high field junctions of these arrays is on the order of 10⁶, which enables these substrates to approach zeptomolar molecular detection sensitivities. This is a conservative number, sensitive to further enhancements by closer internanoparticle spacings and localized asperities on the surface of individual nanostructures.

TABLE S1
Raman peak assignments of pMA

| Normal Raman (cm⁻¹) | SERS (cm⁻¹) | Assignment |
|---|---|---|
| 1594 | 1585 | CC stretch |
| 1479 | 1487 | CC stretch + CH bend |
| | 1429 | CC stretch + CH bend |
| | 1384 | CH bend + CC stretch |
| 1304 | 1311 | CC stretch + CH bend |
| 1204 | 1179 | CH bend |
| 1168 | 1142 | CH bend |
| 1088 | 1076 | CS stretch |
| 1004 | 1005 | CCC bend + CC bend |
| 817 | 814 | CH wag |
| 631 | 635 | CCC bend |
| | 390 | Au—S stretch |

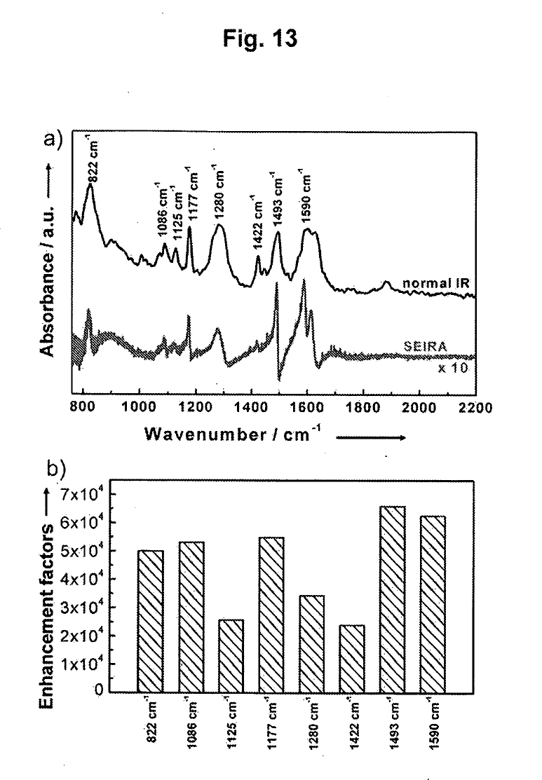

The broad nanoshell array plasmon in the mid infrared region enhances SEIRA quite well. FIG. 13a shows a normal IR spectrum of neat pMA film (0.60 mm thick) supported on a silicon wafer and a typical SEIRA spectrum of SAMs of pMA formed on the nanoshell array surfaces (see detailed peak assignments in Table S2). Utilizing the nanoshell arrays as SEIRA substrates enables the acquisition of high-quality SEIRA spectra of pMA across much of the IR fingerprinting region, enhancing several characteristic vibrational modes that correspond to most of the normal IR features of the molecule. The most striking difference between SEIRA and normal IR spectra is the highly asymmetric, characteristic Fano-type lineshape of SEIRA, which is believed to be due to the interaction between the molecular vibrations and the electronic excitations in the metallic substrates. The SEIRA enhancement factors were determined by directly comparing the ratios of the normalized intensity of SEIRA modes to the corresponding unenhanced IR signals from neat pMA films, in precisely the same manner that we determined the SERS enhancements on the same substrate. The SEIRA enhancement factors of each of the observed IR modes of pMA are shown in FIG. 13b. For this substrate and measurement approach, the SEIRA enhancement factors of pMA on the nanoshell arrays for all observed modes are on the order of 10⁴. We have also performed SEIRA measurements of pMA SAMs on a planar Au surface and isolated nanoshells. However, no signals were observed as neither the planar Au surface nor isolated nanoshells can provide the large local field enhancements associated the broadband mid infrared plasmons. The remarkably large enhancement factors and high reproducibility of the SEIRA spectra obtained on these substrates open new opportunities for the broader development of SEIRA as a reliable and reproducible spectroscopy. spectroscopies, allowing more detailed investigations of molecular structure, orientation and conformation, adsorbate-substrate and adsorbate-adsorbate interactions. This substrate geometry also provides a system for detailed and highly reproducible correlations between surface-field properties and spectroscopic enhancements, which should enhance our ability to unravel the complex mechanisms involved in surface-enhanced spectroscopic processes.

TABLE S2
IR peak assignments of pMA

| Normal IR (cm⁻¹) | SEIRA (cm⁻¹) | Assignment |
|---|---|---|
| 1628 | 1612 | NH bend |
| 1590 | 1587 | CC stretch |
| 1495 | 1490 | CC stretch + CH bend |
| 1422 | 1419 | CC stretch + CH bend |
| 1177 | 1172 | CH bend |
| 1125 | 1118 | CH bend |
| 1086 | 1084 | CS stretch |
| 822 | 819 | CH wag |

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}, —R_{L}) wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A composition comprising a substrate and at least one adsorbate associated with the substrate wherein the composition has an enhanced infrared absorption spectra.

2. The composition of claim 1 wherein the substrate comprises nanoparticle aggregates, periodic aggregates or combinations thereof.

3. The composition of claim 2 wherein the nanoparticle aggregates comprise equal to or greater than about 3 nanoparticles per aggregate.

4. The composition of claim 2 wherein the individual nanoparticles in the nanoparticle aggregate comprise a shell surrounding a core material with a lower conductivity than the shell material, and the thickness of the core material and the shell material is tuned to generate a plasmon resonance frequency in the near-IR.

5. The composition of claim 2 wherein the nanoparticle aggregates have a plasmon resonance in the mid-IR.

6. The composition of claim 2 wherein the periodic aggregates have domain sizes ranging from about tens of microns to equal to or greater than about 200 microns.

7. The composition of claim 2 wherein the nanoparticle aggregates are contacted with a medium.

8. The composition of claim 7 wherein the medium comprises a solid support, a liquid, or combinations thereof.

9. The composition of claim 7 wherein the medium comprises a highly refractive material.

10. The composition of claim 7 wherein the medium comprises glass, silica, alumina, or combinations thereof.

11. The composition of claim 1 wherein the substrate comprises one or more discrete nanoparticles.

12. The composition of claim 11 wherein the discrete nanoparticles comprise a shell surrounding a core material with a lower conductivity than the shell material, and the thickness of the core material and the shell material is tuned to generate a plasmon resonance frequency in the mid-IR.

13. The composition of claim 2 wherein the aggregates comprise individual particles having a spherical or elliptical shell, nanotriangles, or combinations thereof.

14. The composition of claim 1 wherein the adsorbate comprises an organic molecule, a biomolecule, or combinations thereof.

15. The composition of claim 1 wherein the adsorbate comprises O-ethyl-S-[2(diisopropylamino)ethyl]methylphosphonothiolate (VX); O-Isopropyl methylphosphonofluoridate (sarin); O-Pinacolyl methylphosphonofluoridate (Soman); Ethyl N,N-dimethylphosphoramidocyanidate (Tabun); 2-azabicyclo[2.2.2]Oct-3-yl α-hydroxy-α-phenylbenzeneacetate (BZ); or combinations thereof.

16. The composition of claim 1 wherein the adsorbate is associated with the nanoparticle by an electrostatic interaction, by at least one chemical bond, by physical association, or combinations thereof.

17. The composition of claim 1 wherein the substrate and the adsorbate are chosen to produce a surface enhanced infrared absorption (SEIRA) spectra.

18. The composition of claim 17 wherein the SEIRA spectra exhibit an enhancement of greater than about 10³.

19. The composition of claim 17 wherein the SEIRA spectra of the adsorbate is chemically and/or physically responsive.

20. The composition of claim 19 wherein the adsorbate-substrate composition is a sensor device sensing the chemical and/or physical response.

21. A method comprising:
tuning a nanoparticle to display a plasmon resonance in the infrared;
associating an adsorbate with the nanoparticle to form an adsorbate associated nanoparticle; and
aggregating the adsorbate associated nanoparticle.

22. A method of preparing a SERS-SEIRA composition comprising fabricating a nanoparticle substrate;
functionalizing the nanoparticle substrate to form a functionalized substrate;
dispersing the functionalized substrate in solution to form a dispersed functionalized substrate; and
associating the dispersed functionalized substrate with a medium.

23. The method of claim 22 wherein functionalizing the substrate comprises contacting the substrate with a surfactant.

24. The method of claim 22 further comprising associating the SERS-SEIRA composition with an adsorbate.

25. The method of claim 22 wherein the SERS spectral response of the adsorbate is enhanced by a factor of from about 10⁸-10⁹.
